(19) United States
(12) Patent Application Publication
(10) Pub. No.: US 2008/0302880 A1
(43) Pub. Date: Dec. 11, 2008

(54) Motor cooling device

(75) Inventors: Gerry E. Eubank, Arlington, TX (US); Paul S. Komisarz, Saginaw, TX (US)

Correspondence Address: FAY SHARPE LLP, 1100 SUPERIOR AVENUE, SEVENTH FLOOR, CLEVELAND, OH, 44114, US

(73) Assignee: Dreison International, Inc.

(21) Appl. No.: 11/811,205

(22) Filed: Jun. 8, 2007

(51) Int. Cl. B60H 1/22; F24H 3/02

(52) U.S. Cl. 237/28; 137/565.01; 165/122

(57) ABSTRACT

A static motor cooling device for a centrifugal blower or axial fan assembly is provided. The blower or fan assembly includes an electric motor, a motor housing for enclosing the electric motor, a drive shaft operably coupled to the electric motor and extending outwardly from the motor housing, and a blower wheel or fan blade operably connected to the drive shaft. The blower or fan includes a blower or fan housing to which the motor housing is at least partially mounted. The motor cooling device comprises a shroud and at least one mounting provision. The motor cooling device is mounted over the motor housing and configured to mate with the blower or fan housing for passively directing a portion of the air being drawn into the blower or fan assembly over the motor housing for cooling the electric motor.

### BACKGROUND

The present disclosure relates to an auxiliary, static motor cooling device. It finds particular application in conjunction with centrifugal blowers and axial fans for passively directing air over a drive motor for cooling the drive motor, and will be described with particular reference thereto. However, it is to be appreciated that the present disclosure is also amenable to other like applications.

A blower assembly or axial fan includes an electric drive motor for rotating a blower wheel or fan blade. The motor generates heat, which may be detrimental to the operating life of the motor. For instance, the motor may have a reduced operating life at higher temperature, or alternatively, the internal components of the motor may burn or melt, thus resulting in premature failure of the motor. It is known to provide a flow of air to the drive motor for cooling purposes. This flow of air may be directed in contact with the internal rotating assembly, or be directed in contact with the outer housing of the motor.

Currently, there are several methods to cool electric drive motors with an airflow. Generally, these methods are incorporated in the design of the electric drive motor and require that a secondary source of air be provided. One such method is an open vented electric motor. In this design, a motor housing is provided with a plurality of openings, which allow airflow into the motor interior, where it comes in contact with a rotating armature, which is the principal source of heat. However, vented electric motors cannot be used in certain environments, which require the motor to be protected or sealed. For example, in marine applications, 33 CFR §83.410, entitled “Ignition Protection” requires that all electrical motors used on gasoline powered boats be ignition protected, unless the motor is isolated from the source of fuel. Other examples would be very dusty environments, such as agricultural or mining applications, and applications requiring the motor to be sealed submersion proof, such as frequently encountered in military vehicles.

Another common method for cooling electric blower motors is to provide a passage from a discharge, or higher-pressure area of a blower housing, through the motor, and then exhausted back into an inlet or lower-pressure area of the blower wheel. Although this method provides an effective manner to cool the motor, there is generally a loss in efficiency as air is diverted from the primary discharge purely for motor cooling. This design is also not compatible with liquid or vapor tight applications; such as in explosive, corrosive, condensing humidity, extremely dusty environments, or those requiring the motor to retain it's operating integrity after having been submerged. Examples of this cooling method are taught in U.S. Pat. Nos. 4,866,320, 5,743,721, and 5,954,488.

Another known cooling method positions the electric motor in an inlet path of the airflow. Thus motor cooling is provided by air flow over the motor housing. Such an arrangement is disclosed in U.S. Pat. No. 6,927,509.

Other common cooling methods require the addition of an additional fan impeller to cool the motor. This adds cost, increases package size, and adds an additional load to the motor. Typically these methods can be divided into two groups, Open Fan Cooled (OFC) and Totally Enclosed Fan Cooled (TEFC). U.S. Pat. Nos. 6,933,638, 6,561,772, 7,037,084, 6,411,000, and 5,967,764 disclose various OFC designs. U.S. Pat. Nos. 5,019,737, 6,239,521, 5,925,947, and 6,093,990 disclose various TEFC designs.

More exotic air-cooled designs require a completely separate source of cooling air. U.S. Pat. No. 5,998,896 teaches a motor housing with a separate blower assembly attached for cooling purposes. U.S. Pat. No. 6,164,084 teaches an electric blower motor receiving compressed air from an air cycle air conditioning system for motor cooling. U.S. Pat. No. 6,355,995 teaches electric motor cooling by means of injecting compressed air from an industrial source directly into the motor casing.

It is therefore desirable to provide a passive means for cooling the motor. The present disclosure provides a motor cooling device which overcomes certain difficulties with the prior art designs while providing the advantages of low cost, no moving parts to decrease efficiency or product life, and negligible effect on performance of the blower or fan assembly so equipped.

### BRIEF DESCRIPTION

In accordance with one aspect of the present disclosure, a static motor cooling device for a blower assembly is provided. The blower assembly includes an electric motor, a sealed motor housing for enclosing the electric motor, a drive shaft operably coupled to the electric motor and extending outwardly from the motor housing, and a blower operably connected to the drive shaft. The blower includes a blower housing to which the motor housing is at least partially mounted. The static motor cooling device comprises a shroud and at least one mounting flange. The motor cooling device is mounted over the motor housing and configured to mate with the blower housing for passively directing air being drawn into the blower assembly over the motor housing for cooling the electric motor.

In accordance with another aspect of the present disclosure, a heating system for a vehicle is provided. The heating system comprises a blower assembly, a heater and a static motor cooling device. The blower assembly includes an electric motor, a sealed motor housing for enclosing the electric motor, a drive shaft operably coupled to the electric motor and extending outwardly from the sealed motor housing, and a blower operably connected to the drive shaft. The heater houses a heat exchanger. The blower assembly is mounted to an inlet end section of the heater. The motor cooling device is mounted over the sealed motor housing and passively directs air being drawn into the blower assembly over the motor housing for decreasing the operating temperature of the electric motor with minimal effect on power consumption and air output of the heating system.

In accordance with yet another aspect of the present disclosure, an airflow system for a vehicle is provided. The airflow system comprises a blower assembly. The blower assembly includes an electric motor, a sealed motor housing for enclosing the electric motor, a drive shaft operably coupled to the electric motor and extending outwardly from the sealed motor housing, and a blower operably connected to the drive shaft. The airflow system further comprises means for passively directing air being drawn into the blower assembly over the motor housing for decreasing operating temperature of the electric motor. The means for directing has minimal effect on power consumption and air output of the heating system.

### BRIEF DESCRIPTION OF THE DRAWINGS

FIGS. 1 and 2 are respective top and bottom perspective views of a motor cooling device according to one aspect of the present disclosure.

FIG. 3 is a partially exploded front elevational view of a heating system for a vehicle including the motor cooling device of FIGS. 1 and 2.

FIG. 4 is a partially exploded side perspective view of the heating system of FIG. 3.

FIGS. 4A and 4B are partial side views of alternative mounting elements of the motor cooling apparatus of FIGS. 1 and 2.

FIG. 5 is a side perspective view, partially broken away, of the heating system of FIG. 3 showing a cooling airflow path.

FIGS. 6, 7 and 8 are respective top plan, front elevational and side elevational views of the heating system of FIG. 5.

FIGS. 9 and 10 are respective top and bottom perspective views of a motor cooling device according to a second aspect of the present disclosure.

FIGS. 11 and 12 are respective exploded perspective and side elevational views of an axial fan including the motor cooling device of FIGS. 9 and 10.

FIG. 13 is a top perspective view, partially broken away, of the axial fan of FIG. 11 showing a cooling airflow path.

FIG. 14 is a side elevational view of the axial fan of FIG. 13, in partial cross-section.

FIGS. 15 and 16 are respective top and bottom perspective views of a motor cooling device according to a third aspect of the present disclosure.

FIGS. 17 and 18 are respective exploded perspective and side elevational views of an axial fan including the motor cooling device of FIGS. 15 and 16.

FIG. 19 is a top perspective view, partially broken away, of the axial fan of FIG. 17 showing a cooling airflow path.

FIG. 20 is a side elevational view of the axial fan of FIG. 19, in partial cross-section.

### DETAILED DESCRIPTION

It should, of course, be understood that the description and drawings herein are merely illustrative and that various modifications and changes can be made in the structures disclosed without departing from the present disclosure. It will also be appreciated that the various identified components of the heating assembly and axial fan disclosed herein are merely terms of art that may vary from one manufacturer to another and should not be deemed to limit the present disclosure. All references to direction and position, unless otherwise indicated, refer to the orientation of the motor cooling device illustrated in the drawings and should not be construed as limiting the claims appended hereto.

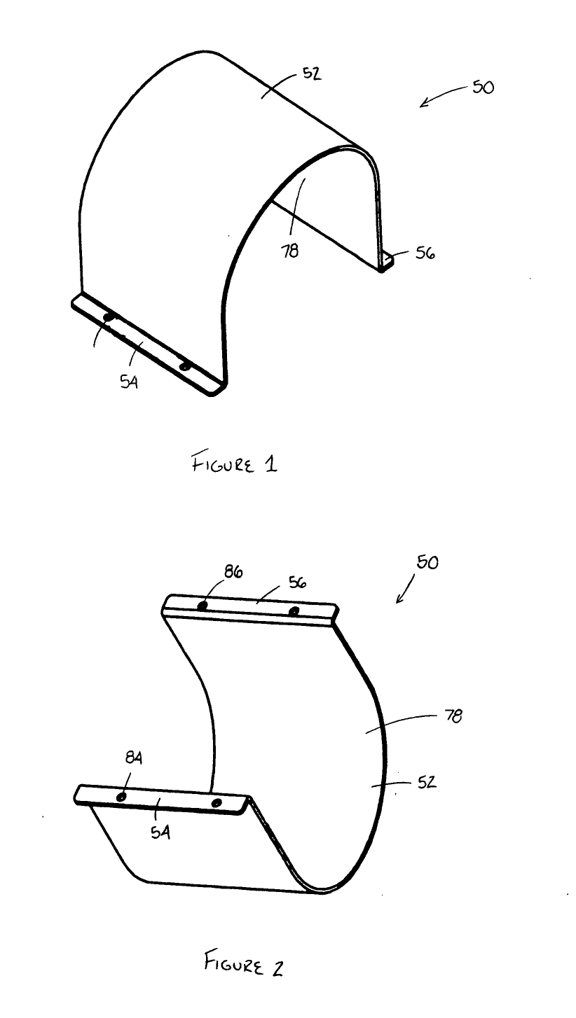

Referring now to the drawings, wherein like numerals refer to like parts throughout the several views, FIGS. 1 and 2 illustrate a static motor cooling device 50 according to one aspect of the present disclosure. The motor cooling device 50 comprises a shroud 52 and at least one mounting flange. In the depicted embodiment, the shroud is formed as a unitary product; although, it should be appreciated that the shroud can be formed of multiple connected sections. The at least one mounting flange includes first and second opposed mounting flanges 54 and 56, respectively, extending outwardly from the shroud. The flanges serve the purpose of mounting the device and it should be appreciated that other means may be provided to accomplish this.

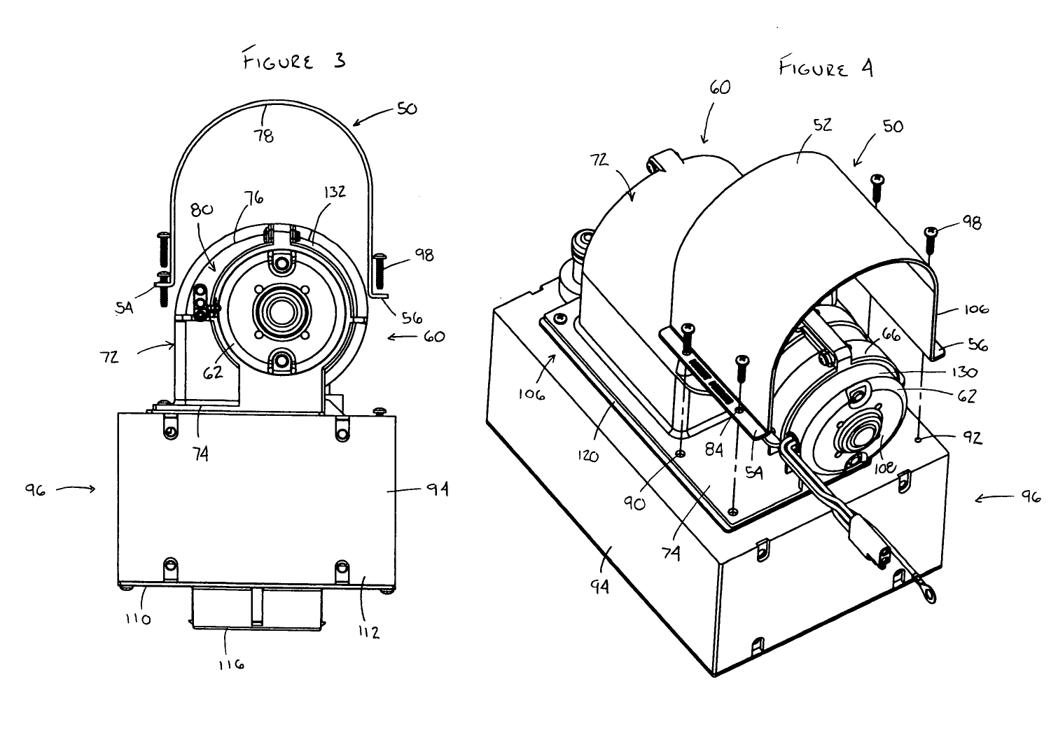

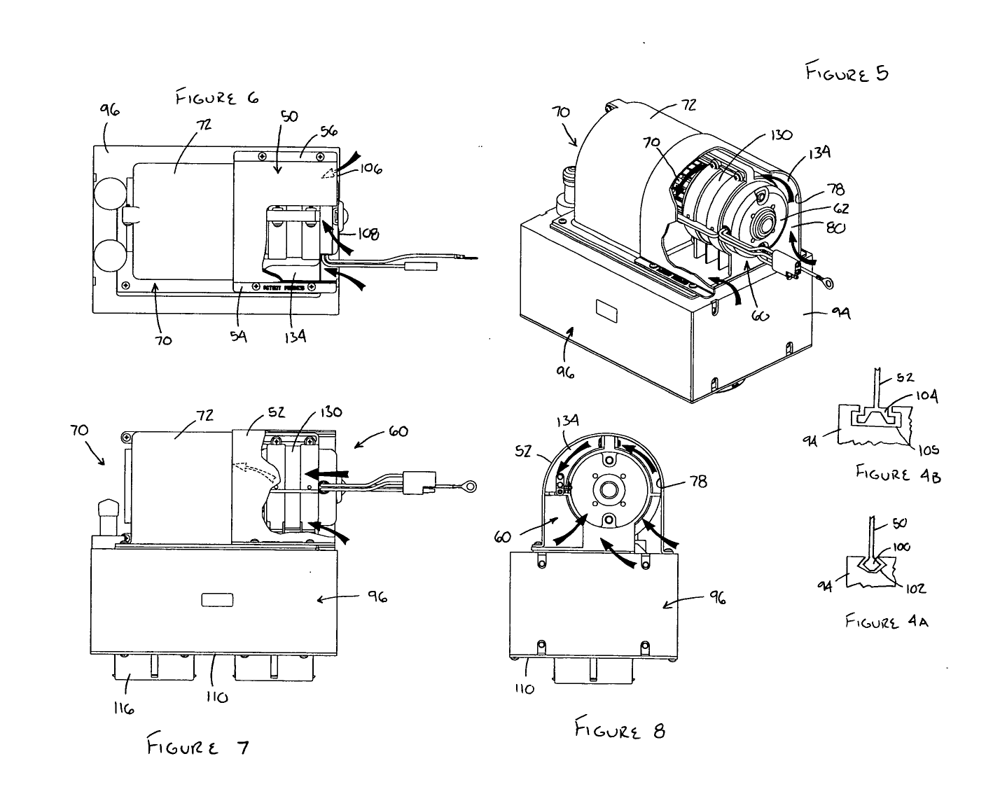

With reference to FIGS. 3 and 4, the motor cooling device 50 is releasably connected to a blower assembly 60. As shown, the shroud 52 is at least partially mounted over the blower assembly; although, this is not required. The blower assembly generally includes an electric motor housing 62. A drive shaft (not visible) is operably coupled to an electric motor (not visible) and extends outwardly from the motor housing 62. A blower wheel 70 (FIG. 5), is operably connected to the drive shaft, is enclosed within a blower housing 72, which is secured to a mounting plate 74. A mounting bracket 66 is coupled to the mounting plate to which the motor housing 62 is at least partially mounted.

The motor cooling device is configured to mate with the blower housing 72 to passively direct air being drawn into the blower assembly 60 over the motor housing for cooling the electric motor. More particularly, the shroud 52 has a conformation generally similar to the conformation of the blower housing 72 so that an inner surface 76 of the blower housing and an inner surface 78 of the shroud at least partially define a continuous air passageway 80. In the illustrated embodiment, both the blower housing 72 and the shroud 52 are generally U-shaped, each extending through an arc approximately equal to one hundred eighty degrees (180°). Although, it should be appreciated that alternative shapes for the blower housing 72 and shroud 52 are contemplated.

As shown in FIGS. 3 and 4, the motor cooling device 50 is positioned over the motor housing 62, at least one of the mounting flanges being adjacent the blower assembly 70. More particularly, the first and second flanges 54, 56 include respective openings 84, 86, either of which align with openings 90 located on the mounting plate 74. As shown, openings 84 register with openings 90 and openings 86 register with openings 92 located on a heater box 94 of a heating system 96 for an associated vehicle, such as a watercraft. The openings are dimensioned to receive conventional fasteners, such as the illustrated bolts 98. As indicated previously, alternative manners for mounting the motor cooling device 50 are contemplated. For example, at least one of the motor cooling device 50 and the heater box 94 can include longitudinally extending tongues 100 and the other can include corresponding longitudinally extending grooves 102. Alternatively, bottom edges of the shroud 52 can include resilient tabs or snaps 104 which can be received in corresponding grooves 105 located on the heater box 94.

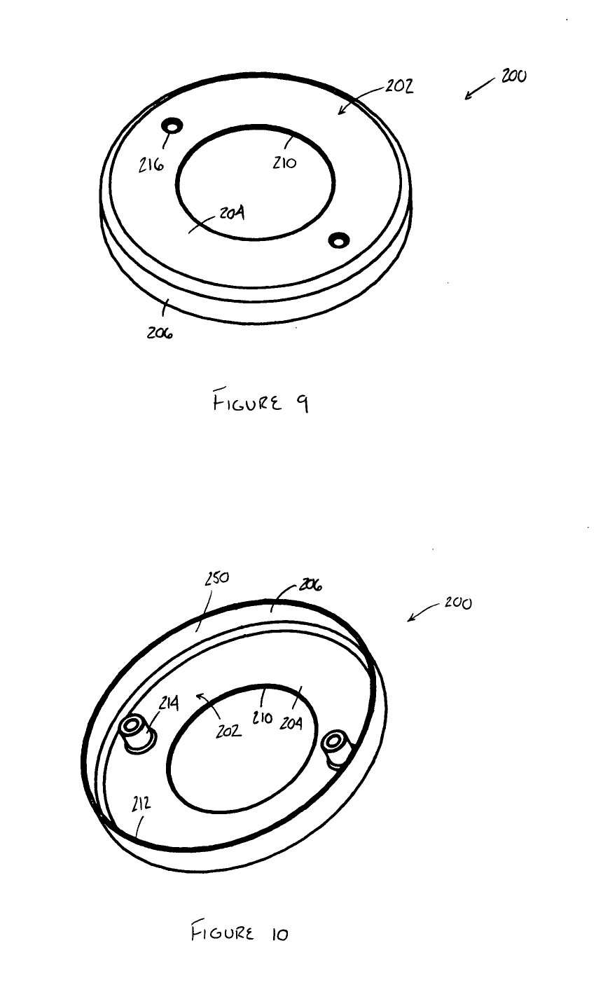

As shown in FIGS. 6 and 7, once mounted, the motor cooling device 50 has an axial dimension or length approximately equal to an axial dimension or length of the motor housing 62. An end portion 106 of the shroud defines a first plane and an end portion 108 of the motor housing defines a second plane, the first plane being generally co-planar with the second plane. A height of the motor cooling device 50 is approximately equal to a height of the blower assembly 70. Thus, the dimensions of the motor cooling device 50 do not substantially increase the physical envelope of the heating system 96 to which it is attached.

The heating system 96 includes the heater box 94 which houses a heat exchanger. The sealed blower assembly 72 is mounted to an inlet end section 106 of the heater box for delivering an air stream through the heater box. The air stream is heated by the heat exchanger. A cover 110 is removably mounted to an outlet end section 112 of the heater box. The cover has at least one outlet 116 in communication with the outlet end section, the outlet being configured to direct the air stream in a predetermined direction. The outlet can include a plurality of louvers (not shown); although, this is not required. The heating system can further include a gasket 120, such as a thermoplastic gasket, disposed between the blower assembly 72 and the heater box 94.

With reference to FIGS. 5-8, the shroud inner surface 78 (FIG. 8) is radially spaced from an external surface 130 (FIG. 7) of the motor housing 62. As shown in FIG. 3, the inner surface 76 of the blower housing 72 and the inner surface 78 of the shroud can define a continuous air passageway 80. A first section 132 of the air passageway extends through the blower housing (FIG. 3). As shown in FIG. 7, a second section 134 of the air passageway 80 is defined between the shroud inner surface 78 and the motor housing external surface 130. As shown by the cooling air path in FIGS. 5-8, the air passageway second section 134 passively directs air being drawn into the blower assembly 70 substantially over the external surface 130 of the motor housing 62. As will be described in greater detail with reference to the test examples, because the motor cooling device 50 is a static device having no moving parts and requiring no energy input, the passive air flow generated by the device 50 decreases the operating temperature of the electric motor with no detrimental effect on power consumption and air output of the heating system 96.

The following confirmation test examples provide further description of the present disclosure, but are not intended to show any limitation to the scope of the disclosure defined in the appended claims. The test examples have slight differences in inlet air temperature and density. To keep these influences and the influence of variations in test configuration to a minimum, each set of two tests were performed on the same day. The addition and removal of the static motor cooling device 50 did not require removal of the blower assembly 70 from the test stand, or the thermocouple from the electric motor, thus test configuration was also identical for each set of two tests.

As evident from the first test tables below, at a high speed (each data point having an airflow reduction of approximately 1.4% and a current reduction of approximately 1.6%), the temperature of the electric motor decreased by an average of approximately 41.7 F. At a medium speed (each data point having an airflow reduction of approximately 5.5% and a current reduction of approximately 7.0%), temperature of the electric motor decreased by an average of approximately 60.5 F. At a low speed (each data point having an airflow reduction of approximately 4.4% and a current reduction of approximately 1.7%), temperature of the electric motor decreased by an average of approximately 23.3 F.

TABLE 1

| | High Speed | | | Medium Speed | | | Low Speed | | |
|---|---|---|---|---|---|---|---|---|---|
| In/H2O | Total Flow | 13.5 v | Temp | Total Flow | 13.5 v | Temp | Total Flow | 13.5 v | Temp |
| Static | CFM | Amps | F. | CFM | Amps | F. | CFM | Amps | F. |

Test blower #1 without motor cooling device
May 25, 2006, Barometer 29.91 in/hg, DB = 74 F., WB = 63 F.

| | | | | | | | | | |
|---|---|---|---|---|---|---|---|---|---|
| 0 | 223.2 | 10.3 | 161 | 166.2 | 6.6 | 195 | 148.6 | 5 | 159 |
| 0.1 | 224 | 10.2 | 162 | 160.2 | 6.5 | 193 | 141.8 | 4.9 | 158 |
| 0.2 | 216.6 | 10 | 164 | 155.8 | 6.5 | 186 | 139.4 | 4.9 | 157 |
| 0.3 | 209.5 | 9.9 | 166 | 154.1 | 6.4 | 186 | 130.4 | 4.7 | 157 |
| 0.4 | 205.6 | 9.7 | 167 | 145.6 | 6.3 | 185 | 123.5 | 4.7 | 152 |
| 0.5 | 199.4 | 9.6 | 168 | 141 | 6.2 | 183 | 117.4 | 4.6 | 150 |
| 0.6 | 195.3 | 9.4 | 170 | 134.3 | 6.1 | 183 | | | |
| 0.7 | 191.1 | 9.3 | 171 | 128.8 | 6.1 | 182 | | | |
| 0.8 | 182.9 | 9.2 | 169 | 115.5 | 5.8 | 182 | | | |
| 0.9 | 179.4 | 9 | 168 | 109 | 5.6 | 182 | | | |
| 1 | 171.4 | 8.9 | 163 | 91.4 | 5.4 | 180 | | | |
| 1.2 | 156 | 8.6 | 164 | | | | | | |
| 1.4 | 141.5 | 8 | 166 | | | | | | |

Test blower #1 with motor cooling device
May 25, 2006, Barometer 29.98 in/hg, DB = 76 F., WB = 67 F.

| | | | | | | | | | |
|---|---|---|---|---|---|---|---|---|---|
| 0 | 224.1 | 10.3 | 120 | 165.2 | 6.7 | 136 | 147.4 | 5.1 | 131 |
| 0.1 | 216.7 | 9.9 | 121 | 163 | 6.7 | 137 | 140 | 5 | 131 |
| 0.2 | 215.4 | 9.8 | 123 | 158.9 | 6.6 | 137 | 128.8 | 5 | 132 |
| 0.3 | 208.7 | 9.8 | 123 | 156.8 | 6.6 | 137 | 123.9 | 4.9 | 132 |
| 0.4 | 204.7 | 9.6 | 125 | 147.2 | 6.4 | 135 | 116.3 | 4.7 | 133 |
| 0.5 | 201.6 | 9.4 | 125 | 140.6 | 6.2 | 138 | 108.7 | 4.6 | 134 |
| 0.6 | 192 | 9.3 | 126 | 132.5 | 6.1 | 138 | | | |
| 0.7 | 186.8 | 9.1 | 125 | 127.1 | 6 | 137 | | | |
| 0.8 | 181.9 | 9 | 126 | 116.3 | 5.8 | 138 | | | |
| 0.9 | 176.8 | 8.8 | 127 | 111.4 | 5.7 | 139 | | | |
| 1 | 168.3 | 8.8 | 126 | | | | | | |
| 1.2 | 151.4 | 8.4 | 125 | | | | | | |
| 1.4 | 133.3 | 7.9 | 125 | | | | | | |

As evident from the second test tables below, at a high speed (each data point having an airflow reduction of approximately 1.6% and a current reduction of approximately 1.0%), temperature of the electric motor decreased by an average of approximately 45.5 F. At a medium speed (each data point having an airflow reduction of approximately 3.9% and a current reduction of approximately 0.2%), temperature of the electric motor decreased by an average of approximately 25.0 F. At a low speed (each data point having an airflow reduction of approximately 2.4% and an approximately constant current), temperature of the electric motor decreased by an average of approximately 25.2 F.

TABLE 2

| | High Speed | | | Medium Speed | | | Low Speed | | |
|---|---|---|---|---|---|---|---|---|---|
| In/H2O | Total Flow | 13.5 v | Temp | Total Flow | 13.5 v | Temp | Total Flow | 13.5 v | Temp |
| Static | CFM | Amps | F. | CFM | Amps | F. | CFM | Amps | F. |

Test blower #2 without motor cooling device
May 26, 2006, Barometer 29.86 in/hg, DB = 78 F., WB = 65 F.

| | | | | | | | | | |
|---|---|---|---|---|---|---|---|---|---|
| 0 | 206.5 | 10.3 | 205 | 165.2 | 6.4 | 195 | 131.6 | 5.1 | 191 |
| 0.1 | 199.8 | 10.2 | 204 | 157.7 | 6.3 | 194 | 128.8 | 5 | 190 |
| 0.2 | 196.6 | 10 | 205 | 155.3 | 6.4 | 187 | 122.6 | 4.9 | 191 |
| 0.3 | 192 | 9.8 | 205 | 151.2 | 6.2 | 194 | 118.9 | 4.8 | 193 |
| 0.4 | 190.1 | 9.7 | 206 | 145.2 | 6.1 | 192 | 112.5 | 4.7 | 190 |
| 0.5 | 183.7 | 9.7 | 205 | 142.1 | 6.1 | 187 | 104.7 | 4.6 | 190 |
| 0.6 | 176.7 | 9.6 | 207 | 138.7 | 6 | 187 | | | |
| 0.7 | 180.8 | 9.5 | 208 | 132.2 | 5.9 | 186 | | | |
| 0.8 | 175.2 | 9.3 | 208 | 125.6 | 5.8 | 186 | | | |
| 0.9 | 171.0 | 9.1 | 209 | 112.5 | 5.5 | 187 | | | |
| 1 | 158.4 | 9 | 203 | | | | | | |
| 1.2 | 142.9 | 8.5 | 204 | | | | | | |
| 1.4 | 128.2 | 8.1 | 207 | | | | | | |

Test blower #2 with motor cooling device
May 26, 2006, Barometer = 29.98 in/hg, DB = 78 F., WB = 65 F.

| | | | | | | | | | |
|---|---|---|---|---|---|---|---|---|---|
| 0 | 203.5 | 10.1 | 160 | 163.1 | 6.5 | 161 | 131.6 | 5.1 | 165 |
| 0.1 | 199.4 | 10.1 | 159 | 155.0 | 6.4 | 161 | 129.6 | 5 | 164 |
| 0.2 | 195.8 | 9.9 | 160 | 153.6 | 6.4 | 161 | 122.0 | 4.9 | 164 |
| 0.3 | 191.6 | 9.8 | 160 | 146.5 | 6.3 | 162 | 116.2 | 4.9 | 166 |
| 0.4 | 184.4 | 9.7 | 160 | 143.9 | 6.2 | 162 | 106.2 | 4.7 | 168 |
| 0.5 | 180.9 | 9.7 | 160 | 140.3 | 6.1 | 162 | 96.4 | 4.5 | 167 |
| 0.6 | 178.9 | 9.5 | 160 | 131.9 | 6 | 163 | | | |
| 0.7 | 176.9 | 9.3 | 159 | 123.8 | 5.8 | 163 | | | |
| 0.8 | 174.8 | 9.3 | 160 | 113.3 | 5.6 | 165 | | | |
| 0.9 | 169 | 9.2 | 162 | 100.5 | 5.3 | 160 | | | |
| 1 | 156.6 | 8.9 | 162 | | | | | | |
| 1.2 | 137.1 | 8.3 | 164 | | | | | | |
| 1.4 | 117.1 | 7.8 | 160 | | | | | | |

As is evident from the above test examples, the static motor cooling device 50, which has no moving parts and requires no significant modification to the associated components of the device, such as the heating system 96, to which the device is implemented, significantly reduces the operating temperature of the electric motor.

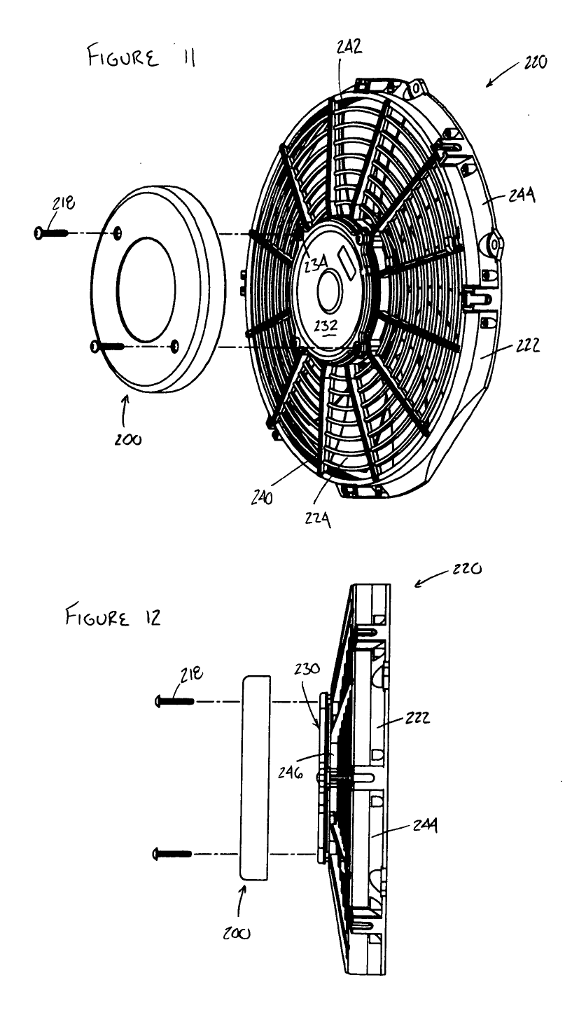

FIGS. 9-14 illustrate a motor cooling device 200 according to a second aspect of the present disclosure.

With reference to FIGS. 9 and 10, the motor cooling device includes a shroud 202 having a generally shallow cup shape; although, alternate configurations for the shroud are also contemplated. The shroud includes a base 204 and a flange 206 extending outwardly from a peripheral edge of the base. The base includes a first air opening 210 having a first diameter. The flange defines a second air opening 212 having a second, larger diameter. The base further includes at least one mounting boss 214 having an opening 216 dimensioned to receive a fastener 218.

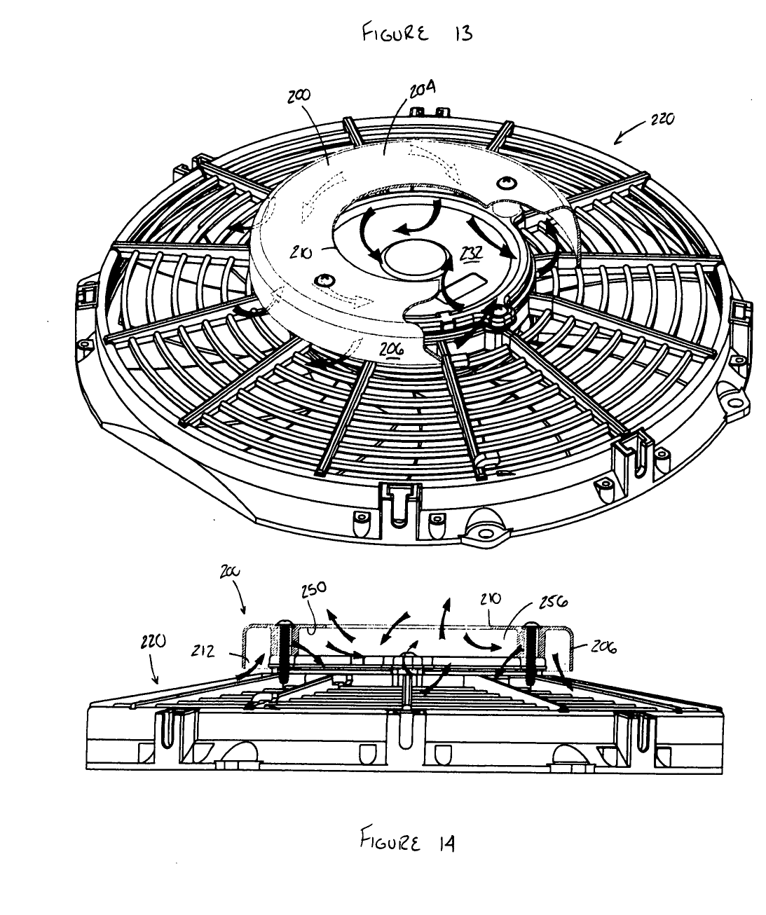

As shown in FIGS. 11 and 12, the motor cooling device 200 is releasably connected to an axial fan assembly 220 for an associated vehicle. The fan assembly includes a housing 222, a fan blade assembly 224 and an electric motor 230. A motor housing 232, which can be sealed, encloses the electric motor. To secure the motor cooling device to the housing, the fasteners 218 extend through the bosses 214 and threadingly engage openings 234 located on the housing. Once secured, the motor cooling device encircles the motor housing, a longitudinal axis of the motor cooling device being generally coincident with a longitudinal axis of the fan.

The fan housing 222 can be of a generally dish-like configuration comprising a plurality of evenly spaced radial ribs 240 and arcuate ribs 242. The ribs form a grid-like pattern which protects the fan blade assembly 224 from foreign objects and prevents contact with the rotating fan blades. The fan housing further includes an outer rim 244 extending circumferentially around the plurality of ribs and an inner rim 246 to which the electric motor is mounted. Further details of the fan assembly 220 are generally conventional and understood by one skilled in the art so that further discussion herein is deemed unnecessary.

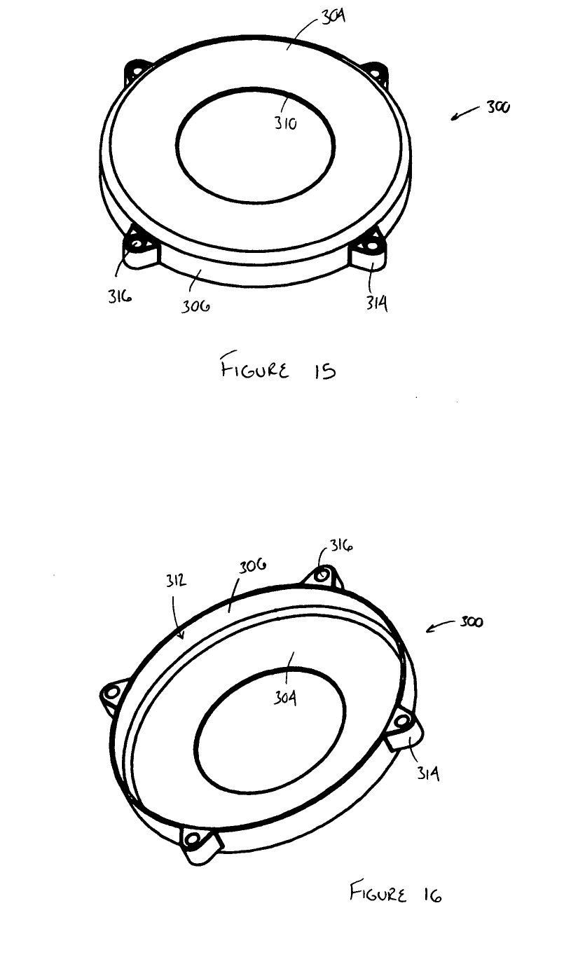

Similar to the previous embodiment, the motor cooling device 200 has a conformation generally similar to the conformation of the fan housing, particularly the inner rim 246. As shown in FIGS. 13 and 14, once mounted, the shroud inner surface 250 is generally concentric with and spaced from the external surfaces of the motor housing 232 and inner rim 246, thereby defining a generally continuous, air passageway 256, of generally constant cross-section, between the motor housing and the shroud. The base 204 is spaced from an end of the motor housing 232 and the diameter of the first air opening 210 is smaller than a width of the motor housing. As shown by the cooling air path, the air passageway 256 passively directs air being drawn into the fan assembly 220 substantially over the external surface of the motor housing 232, thereby cooling it. Again, because the motor cooling device 200 is a static device, having no moving parts and requiring no energy input, the passive air flow generated by the device decreases an operating temperature of the electric motor 230 with no detrimental effect on power consumption and air output of the fan 200.

FIGS. 15-20 illustrate a motor cooling device 300 according to a third aspect of the present disclosure. Since most of the structure and function is quite similar to the second embodiment, reference numerals with a single primed suffix (′) refer to like components (e.g., fan assembly 220 is referred to by reference numeral 220′), and new numerals identify new components in the additional embodiment.

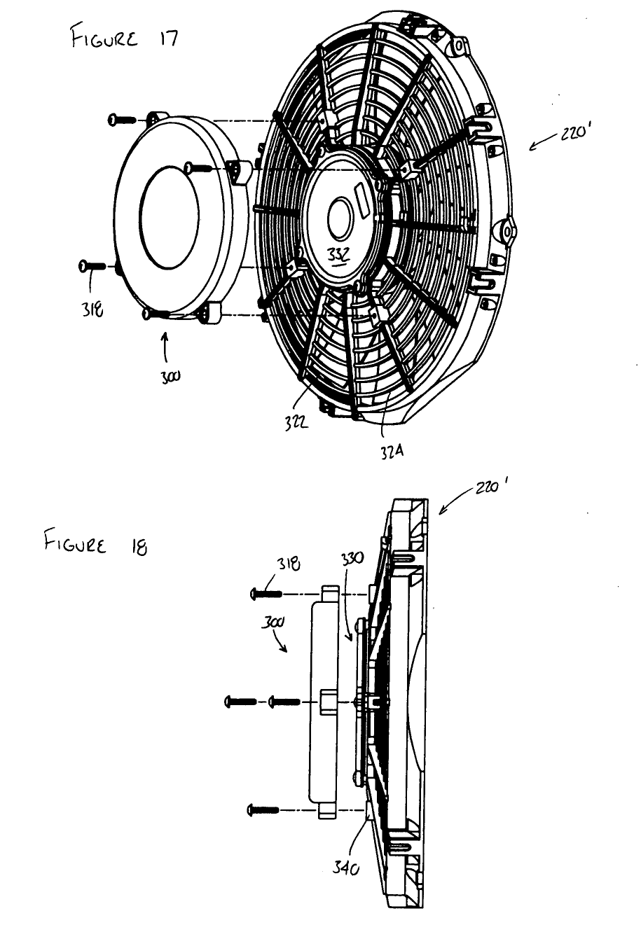

With reference to FIGS. 15 and 16, the motor cooling device 300 has generally a shallow cup shape and includes a base 304 and a flange 306 extending outwardly from the base. The base includes a first air opening 310 having a first diameter. The flange defines a second air opening 312 having a second, larger diameter. A plurality of mounting tabs 314 extend from the flange, each tab having an opening 316 dimensioned to receive a fastener 318.

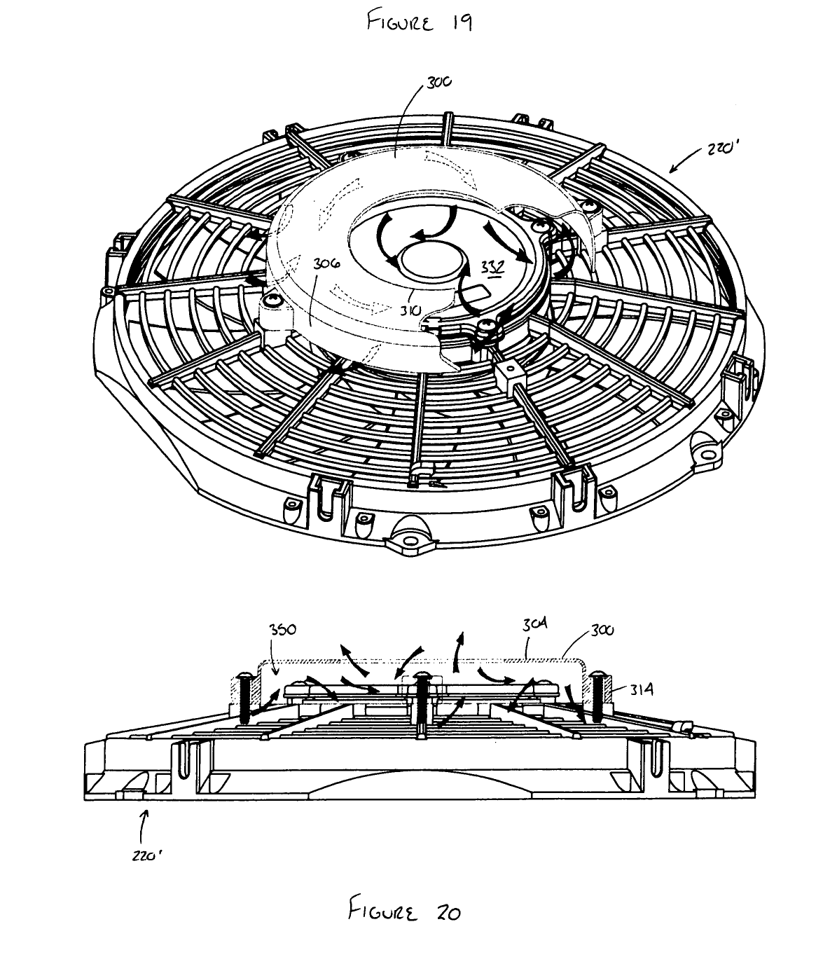

As shown in FIGS. 17 and 18, the motor cooling device 300 is releasably connected to a fan assembly 220′ for an associated vehicle. The fan includes a housing 322, a fan blade assembly 324 and an electric motor 330. A motor housing 332 encloses the electric motor. To secure the motor cooling device to the housing, the fasteners 318 extend through the mounting tabs 314 and threadingly engage mounting blocks 340 located on the housing. Once secured, the motor cooling device encircles the motor housing, a longitudinal axis of the motor cooling device being generally coincident with a longitudinal axis of the fan.

With reference to FIGS. 19 and 20, the motor cooling device 300 encircles the motor housing to define an air passageway 350 which passively directs air being drawn into the fan assembly 220′ substantially over the external surface of the motor housing 332. This airflow cools the electric motor.

It will be appreciated that various of the above-disclosed and other features and functions, or alternatives thereof, may be desirably combined into many other different systems or applications. Also, it should be noted that various presently unforeseen or unanticipated alternatives, modifications, variations or improvements therein may be subsequently made by those skilled in the art, which are also intended to be encompassed by the following claims.

What is claimed is:

1. A static motor cooling device for a centrifugal blower assembly or an axial fan assembly including an electric motor, a motor housing for enclosing the electric motor, a drive shaft operably coupled to the electric motor and extending outwardly from the motor housing, and a centrifugal blower wheel or axial fan blade operably connected to the drive shaft, the blower or fan assembly including a blower or fan housing to which the motor housing is at least partially mounted, the static motor cooling device comprising:
a shroud and at least one mounting element, the motor cooling device being mounted over the motor housing and configured to mate with the blower or fan housing for passively directing air being drawn into the blower or fan assembly over the motor housing for cooling the electric motor.

2. The motor cooling device of claim 1, wherein the shroud has a conformation generally similar to the conformation of the blower housing, wherein a surface of the blower housing and an inner surface of the shroud define a continuous air passageway.

3. The motor cooling device of claim 1, wherein the shroud is generally U-shaped.

4. The motor cooling device of claim 3, wherein at least one mounting element comprises at least one of a flange, a tab, a snap or a tongue-in-groove connector.

5. The motor cooling device of claim 1, wherein the shroud includes an inner surface radially spaced from an external surface of the motor housing, the shroud inner surface and the motor housing external surface defining an air passageway for directing air substantially over the external surface of the motor housing.

6. The motor cooling device of claim 1, wherein the shroud has an axial dimension approximately equal to an axial dimension of the motor housing, wherein an end portion of the shroud defines a first plane and an end portion of the motor housing defines a second plane, the first plane being generally co-planar with the second plane.

7. The motor cooling device of claim 1, wherein the shroud includes an inner surface portion generally concentrically spaced from an external surface portion of the motor housing thereby defining a generally concentric air passageway between the motor housing and the shroud.

8. The motor cooling device of claim 1, wherein the shroud has a generally shallow cup shape and includes a first air opening having a first diameter and a second air opening having a second, larger diameter, the shroud having a longitudinal axis generally coincident with a longitudinal axis of the blower assembly.

9. The motor cooling device of claim 1 in combination with a heating system for a vehicle, the heating system including:
a heater box for housing a heat exchanger, the sealed blower assembly being mounted to an inlet end section of the heater box for delivering an air stream through the heater box, the air stream being heated by the heat exchanger, and
a cover mounted to an outlet end section of the heater box, the cover having at least one outlet in communication with the outlet end section, the at least one outlet configured to direct the air stream in a predetermined direction.

10. The motor cooling apparatus of claim 1, wherein the shroud is generally cup-shaped.

11. A heating system for a vehicle comprising:
a blower assembly including:
an electric motor,
a sealed motor housing for enclosing the electric motor,
a drive shaft operably coupled to the electric motor and extending outwardly from the sealed motor housing, and
a blower operably connected to the drive shaft;
a heater for housing a heat exchanger, the blower assembly being mounted to an inlet end section of the heater; and
a static motor cooling device mounted over the sealed motor housing and passively directing air being drawn into the blower assembly over the motor housing for decreasing an operating temperature of the electric motor with minimal effect on power consumption and air output of the heating system.

12. The heating system of claim 11, wherein the motor cooling device comprises a shroud and at least one mounting element connected to the shroud.

13. The heating system of claim 12, wherein the shroud extends through an arc approximately equal to one hundred eighty degrees (180°).

14. The heating system of claim 12, wherein the shroud includes an inner surface radially spaced from an external surface of the motor housing, the shroud inner surface and the motor housing external surface defining an air passageway for directing air substantially over the external surface of the motor housing.

15. The heating system of claim 12, wherein the shroud has a length approximately equal to a length of the motor housing and a height approximately equal to a height of the blower.

16. The heating system of claim 12, wherein the blower includes a blower housing, the shroud being at least partially mounted over the blower housing.

17. The heating system of claim 11, further comprising an outlet cover mounted to an outlet end section of the heater.

18. An airflow system for a vehicle comprising:
a blower assembly including:
an electric motor,
a motor housing for enclosing the electric motor,
a drive shaft operably coupled to the electric motor and extending outwardly from the motor housing, and
a blower wheel operably connected to the drive shaft; and
means for passively directing air being drawn into the blower assembly over the motor housing for decreasing an operating temperature of the electric motor, wherein the means for directing has minimal effect on power consumption and air output of the heating system.

19. The airflow system of claim 18, wherein the means includes a generally U-shaped shroud mounted adjacent the blower and disposed over the motor housing, the shroud defining an air passageway, the shroud having a length approximately equal to a length of the motor housing and a height approximately equal to a height of the blower.

20. The airflow system of claim 18, wherein the means includes a generally cup-shaped shroud mounted adjacent an axial fan and encircling the motor housing, the shroud including a base spaced from an end of the motor housing, the base including an air opening with a diameter smaller than a width of the motor housing.
